(19) United States
(12) Patent Application Publication
(10) Pub. No.: US 2010/0310326 A1
(43) Pub. Date: Dec. 9, 2010

(54) METHOD AND APPARATUS IN A VACUUM CONVEYING SYSTEM OF MATERIAL

(75) Inventor: Göran Sundholm, Tuusula (FI)

Correspondence Address: BIRCH STEWART KOLASCH & BIRCH, PO BOX 747, FALLS CHURCH, VA, 22040-0747, US

(73) Assignee: MARICAP OY, Vantaa (FI)

(21) Appl. No.: 12/739,543

(22) PCT Filed: Oct. 20, 2008
(86) PCT No.: PCT/FI2008/050588

§ 371 Date: Apr. 23, 2010

(30) Foreign Application Priority Data
Oct. 24, 2007 (FI) 20075749

(51) Int. Cl. B65G 53/24

(52) U.S. Cl. 406/85

(57) ABSTRACT

A method in a vacuum conveying system, which vacuum conveying system comprises at least one feed point (61, 66), a material conveying pipe (100, 101, 102) which is connected to the feed point (61, 66) and at the other end to a separator element (20) in which the material being conveyed is separated from conveying air, and means (3, 3) for providing a pressure difference in the conveying pipe (100, 101, 102) at least for the time of conveying the material. In the method, in the conveying piping (100, 101, 102) is provided an intensified vacuum effect (a vacuum pulse) by an ejector device (4), actuating medium of which ejector device is loaded in a pressure accumulator from which it is conveyed to an ejector nozzle for providing an intense suction in the conveying pipe. The invention also relates to an apparatus.

### BACKGROUND OF INVENTION

The invention relates to a method in a vacuum conveying system according to the preamble of claim 1, which vacuum conveying system comprises at least one feed point, a material conveying pipe which is connected to the feed point and at the other end to a separator element in which the material being conveyed is separated from conveying air, and means for providing a pressure difference in the conveying pipe at least for the time of conveying the material.

The invention also relates to an apparatus according to claim 11.

The invention relates generally to vacuum conveying systems, particularly to collecting and conveying waste, such as conveying household waste.

Systems are known in which waste is conveyed in a piping by means of suction. In these, waste is conveyed for long distances in the piping by suction. Apparatuses are utilised, inter alia, for conveying waste in different institutions. Typical for them is that a vacuum apparatus is used for achieving a pressure difference, in which apparatus underpressure in the conveying pipe is provided with vacuum generators, such as vacuum pumps or an ejector apparatus. In the conveying pipe, there is typically at least one valve element by opening and closing of which make-up air coming in the conveying pipe is regulated.

As a pressure difference of less than 1 bar is only available in the suction (in practice 0.1-0.5 bar). Systems are known in which continuous underpressure is maintained in the conveying piping of waste. The small pressure difference requires that the flow rates in the piping have to be designed high in order to make the material intended for conveying in the piping move. As the waste material passing in the pipe is irregular of its tightness, size and shape, by-pass flow is easily created in the piping whereby vacuum generators/suction devices generating the suction have to be dimensioned extremely large of their capacity and power.

Utilising vacuum pumps extending to the piping is a problem. If an outlet valve is opened somewhere for conveying material to the conveying piping, an intense sound is typically created. This results in an extremely great problem particularly in residential areas. A solution to the problem is that vacuum pumps are not turned on usually until the outlet valve has been opened or a flushing valve at the end of the piping has been opened. In order to be able to make the material being conveyed thus move rapidly, the pumps have to be large for the quick generation of underpressure for being able to underpressurise a pipe of even kilometres long adequately fast. This demands vacuum pumps extremely great of their energy consumption and performance. This, again, causes high energy and maintenance costs. As a solution to the problem, a vacuum accumulator has been suggested in EP0906877 B1. This is particularly unsuitable for large systems, because the volume of the vacuum accumulator should be almost the size of the piping, as only little underpressure, <1 bar, can be supplied. Furthermore, a problem of large vacuum conveying systems of waste is that the volume of the conveying piping being kilometres long is considerable.

An object of this invention is to achieve a totally novel kind of an arrangement into connection with conveying systems of material, by means of which the disadvantages of known arrangements are avoided. Another object of the invention is to provide an arrangement suitable for vacuum conveying systems, by means of which a vacuum pulse required for making the material being conveyed move is provided.

### BRIEF DESCRIPTION OF INVENTION

The invention is based on an idea which utilises pressure medium supplied in higher pressure, by which a suction ejector is used for providing a vacuum pulse momentarily required.

The method according to the invention is mainly characterised by that, in the method, an intensified vacuum effect (a vacuum pulse) is provided in a conveying piping by an ejector device, actuating medium of which ejector device is loaded in a pressure accumulator from which it is conveyed to an ejector nozzle for providing an intense suction in the conveying pipe.

In addition, the method according to the invention is characterised by what is stated in claims 2-10.

The apparatus according to the invention is characterised by that the apparatus comprises an ejector device for providing an intensified vacuum effect (a vacuum pulse) in a conveying pipe and for actuating medium of the ejector device of a pressure accumulator, from which pressure accumulator, pressure medium is conveyed to an ejector nozzle for providing an intensive suction in the conveying pipe.

The apparatus according to the invention is further characterised by what is stated in claims 12-18.

The arrangement according to the invention has numerous significant advantages. When the ejector is triggered, a considerable increase is achieved momentarily which can be multifold in relation to the output of the pump. By this method, a quick start-off of the material in the piping is provided. After this, vacuum pumps maintain the conveying rate. When the pneumatic ejector raises underpressure, additional pumps are turned on which take care of finishing the conveyance. The arrangement according to the invention also substantially decreases the sound problem caused by prior art.

### BRIEF DESCRIPTION OF FIGURES

In the following, the invention will be described in detail by means of an example with reference to the accompanying drawings in which

FIG. 1 schematically shows a system in accordance with an embodiment according to the invention,

FIG. 2 schematically shows a system in accordance with another embodiment according to the invention,

FIG. 3 shows a curve of the variation of underpressure in a conveying piping of a known arrangement, and

FIG. 4 shows a curve of the variation of underpressure in a conveying pipe.

### DETAILED DESCRIPTION OF INVENTION

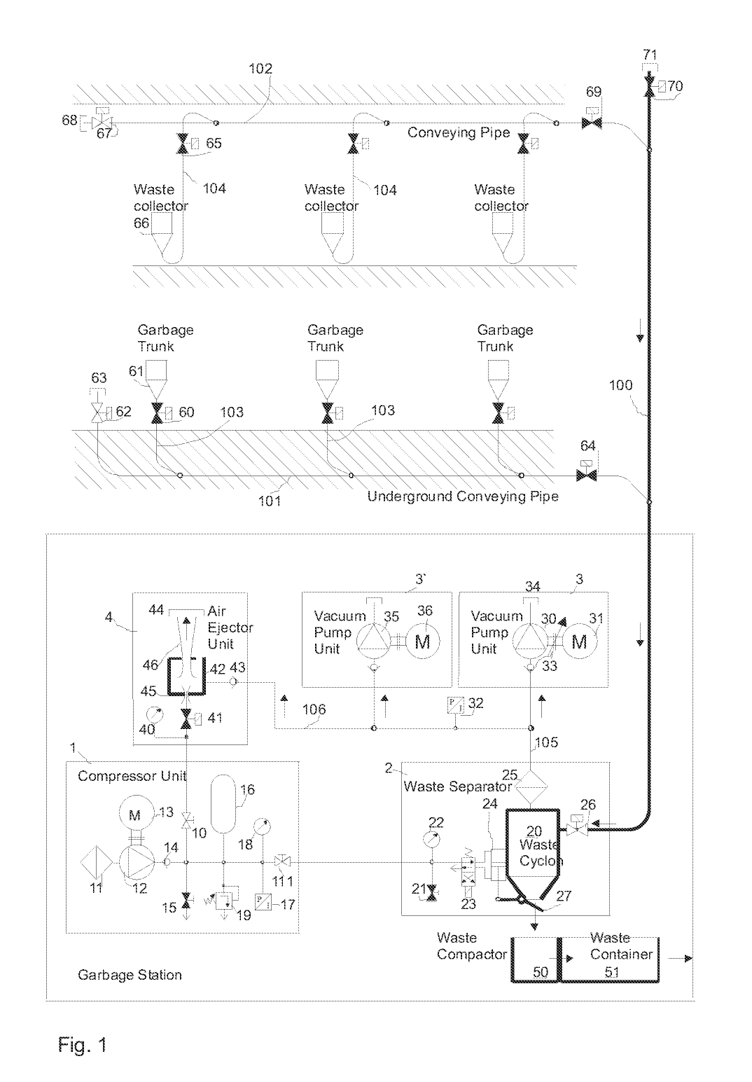

FIG. 1 schematically shows a conveying system of material, particularly a conveying system of waste material, utilising the method and the apparatus according to the invention.

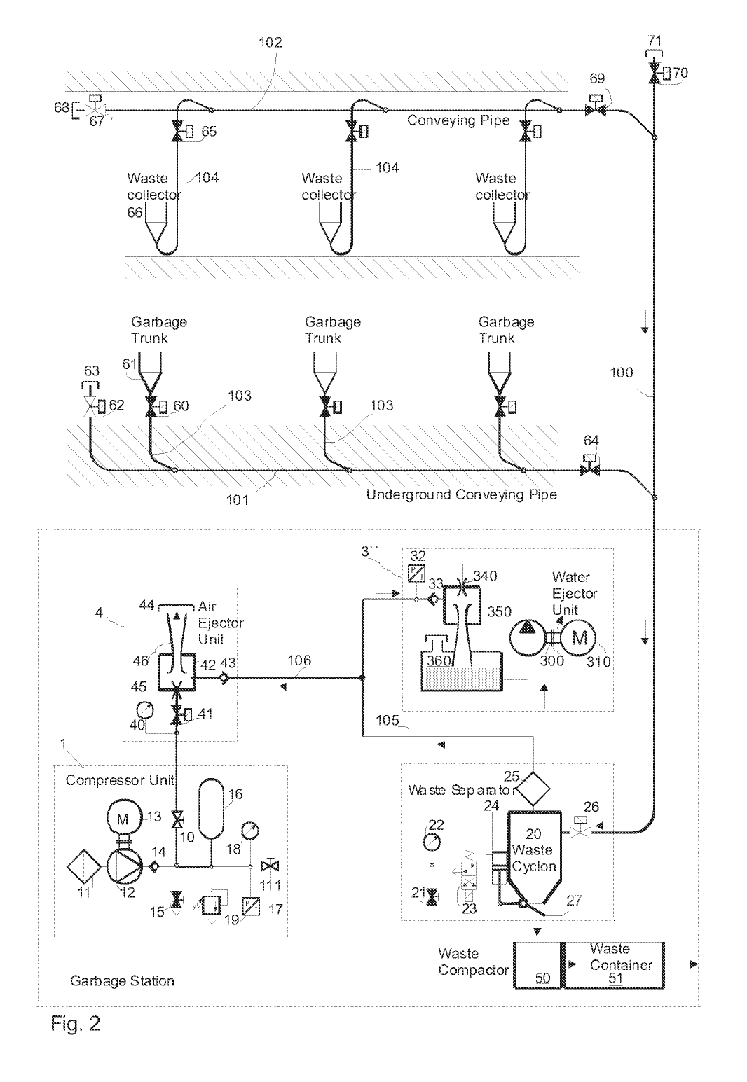

In FIGS. 1 and 2, reference number 61, 66 designates a feed station of waste material intended for conveyance, from which station material, particularly waste material, such as household waste, intended for conveyance is fed to the conveying system. The system can comprise several feed stations 61, 66 from which the material intended for conveyance is fed to a conveying piping 100, 101, 102, 103, 104. Typically, the conveying piping comprises a main conveying pipe 100 into which several branch conveying pipes 101, 102 can have been connected and into which, for their part, several feed stations 61, 66 can have been connected via feed pipes 103, 104. In the embodiment according to FIG. 1, into the main conveying pipe 100 are connected two branch conveying pipes 101, 102. In the figure, into both branch conveying pipes 101, 102 are connected three feed stations 61 and 66. The fed material is conveyed along the conveying piping 100, 101, 102, 103, 104 to a separating device 20 at the opposite end of the conveying piping, in which device the material being conveyed is separated, e.g. by means of centrifugal force, from conveying air. The separated material is removed, e.g. when required, from the separating device 20 to a material container, such as a waste container 51, or for further treatment. The material container can comprise, as in the embodiment of the figures, a waste compactor 50 from which the material is further conveyed to the waste container 51. In the embodiment of FIG. 1, the separating device 20 is provided with material outlet elements. From the separating device 20, a pipe 105 leads to means 3, 4 for generating underpressure in the conveying pipe. In the embodiment of FIG. 1, the means for generating underpressure comprise a vacuum pump unit 3 and an ejector unit 4. By the means for generating underpressure, in the conveying piping 100, 101, 102, 103, 104 is provided underpressure required for conveying the material. The vacuum pump unit 3 comprises a pump 30 which is operated by an actuator 31. In accordance with the invention, the system further comprises the ejector unit 4 which is connected in the embodiment of the figure to the conveying pipe via pipes 106, 105 and the separator element 20.

The ejector unit 4 comprises an ejector nozzle 45 from which actuating medium is sprayed to an ejector 42 into an ejector pipe 46, whereby it provides suction in a pipe 106. The ejector unit 4 is connected to an actuating-medium source, such as a pneumatic source 1, which typically comprises at least one compressor 12 and pneumatic accumulator 16. Underpressure provides the required force for conveying the material in the conveying piping. The ejector unit 4 is connected to the separating device 20, into which, again, the main conveying pipe 100 is connected.

To the feed pipe 103, 104 is arranged an outlet valve 60, 65 which is opened and closed so that material portions of suitable size are conveyed from the feed point 61, 66 to the conveying pipe 101, 102. Material is fed from the feed point 61, 66, such as a waste container, when after the container is full, the outlet valve 60, 65 is opened either automatically or manually. To each conveying pipe 100, 101, 102 is fitted, most suitably at the opposite end of the conveying pipe in respect of the separating device 20, a line valve 62, 67, 70 which is opened and closed when required.

The system operates in the following way: In the start situation, the compressor 12 has loaded the pressure medium accumulator i.e., in the embodiment of FIG. 1, the pneumatic accumulator 16 full in overpressure defined by a pressure sensor 17. The upper limit of load pressure depends on the system. It can be e.g. 10-300 bar, in an embodiment 10-40 bar, and in another embodiment 40-300 bar. An outlet hatch of the separating device 20 is closed and a valve 26 between the main conveying pipe 100 and the separating element is open. The vacuum pump unit 3 maintains underpressure in the main conveying pipe 100. In an embodiment, underpressure in the conveying pipe is e.g. about −0.2 bar. The motor 31 of the vacuum pump 30 of the vacuum unit 3 is controlled by a frequency converter control based on the data of a pressure sensor 32. In the system of FIG. 1, there is also a second pump unit 3′ which does not run in the start situation. The ejector unit 4 does not run in the start situation. All outlet valves 60, 65 in the vicinity of the feed points i.e. waste containers are closed. The line valves 62, 67 of the branch conveying pipes 101, 102 are open. Between the branch conveying pipe 101 and the main conveying pipe 100, there is an area valve 64 and, equivalently between the second branch conveying pipe 102 and the main conveying pipe 100, there is a second area valve 69. In the start situation, the area valves 64 and 69 are closed, as is also the line valve 70 of the main conveying pipe 100.

Let's assume that a waste container of the feed point 61 belonging to the area of the first branch conveying pipe 101 is to be emptied. Based on an emptying signal, the outlet valve 60 and the area valve 64 of the branch pipe 101 are opened and the line valve 62 of the branch pipe 101 is closed. As underpressure decreases in the conveying pipe 100, the vacuum pump tries to increase output and goes to full revolution and the possible second vacuum pump unit 3′ starts up. A valve 41 of the ejector unit is opened, whereby pressure medium gets to the ejector from the pressure accumulator 16. This achieves a smooth but rapid increase of underpressure with no disturbing sound (bang) in the piping. By this, the start-off of material emptied from the waste container of the feed point 61 is ensured in the piping 101, 100. The outlet valve 60 is closed and the line valve 62 is opened typically a few seconds after the start situation. New waste can again be put in the emptied waste container of the feed point. The outlet valves 60, 65 can also be opened as a group or as a group with a small delay in relation to each other.

As the underpressure of the conveying piping decreases e.g. to the value −0.2 bar, the valve 41 of the ejector unit closes and the pressure accumulator 16 is re-loaded with pressure medium, such as compressed air. The vacuum pumps 3, 3′ maintain the desired underpressure in the conveying piping. After a defined time, the valve 64 closes and the line valve 70 of the conveying pipe 100 opens, whereby the material being conveyed continues its conveyance in the conveying pipe 100 to the separator element 20 of the waste station.

When the separating device 20 is full, the valve 26 of the conveying pipe 100 closes and a control valve 23 opens, whereby an actuator 24 of an outlet hatch 27 of the separating device opens the outlet hatch 27 and the material accumulated in the separating device is emptied in the compactor device 51 and further to the waste container 50. The outlet hatch 27 of the separating device 20 is closed and the valve 26 opened.

After this, the start situation is reverted and the emptying process can be repeated or the emptying of some other feed point/feed points can be implemented.

The waste container 51 is replaced or emptied after having become full.

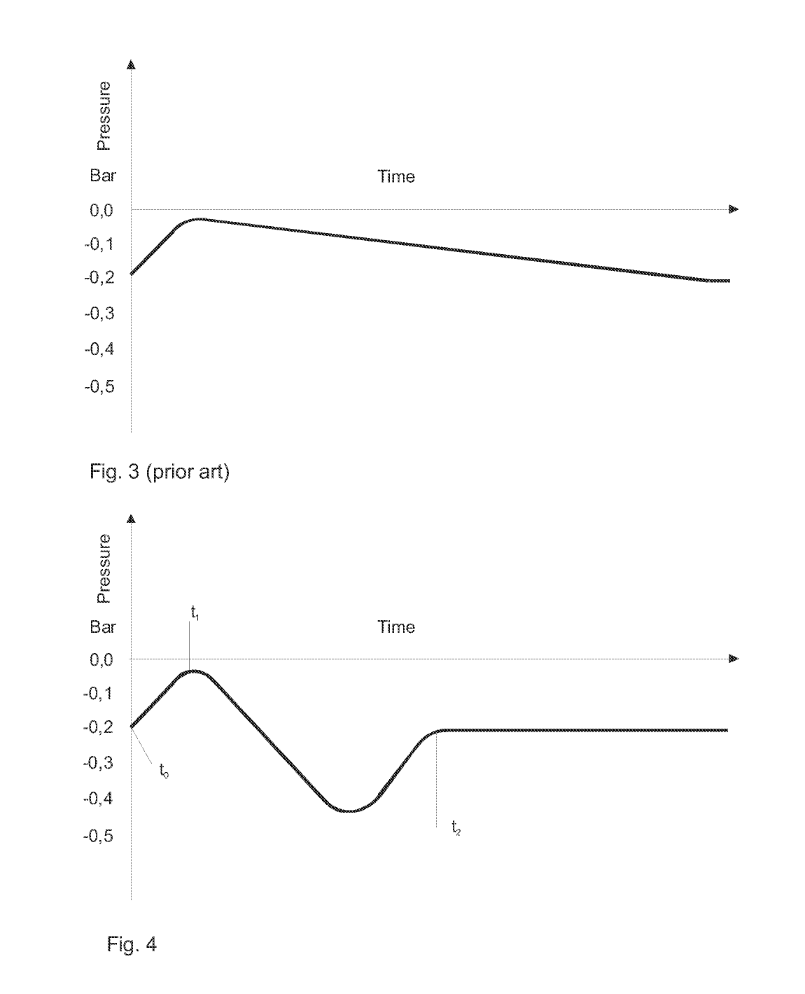

FIG. 3 illustrates the changes of underpressure in the conveying pipe during an emptying process for the part of a prior-art emptying process. Underpressure is first in a set value which is −0.2 bar in the arrangement according to the figure. Underpressure decreases and it takes a long time until the defined underpressure value is achieved. This can lead to the material intended for conveying not starting off well in the conveying pipe. A solution is to grow the size of the pumps, which increases energy consumption. Also, large pumps have their own moment of inertia, whereby starting slows down substantially.

FIG. 4 shows the changes of underpressure in the conveying pipe of the system according to the invention during the emptying process. At point t₀, the valve 62 closes and the valves 60, 64 and 41 open. At point t₁, the valve 62 closes and the valve 64 opens. Underpressure has decreased to its lowest value. A vacuum shock is provided where underpressure increases quickly but smoothly, in the embodiment of the figure to the value of about −0.4 bar. The valve 41 is closed at point t₂. The vacuum pump/pumps maintain the underpressure in the set value of about −0.2 bar. The pressure values shown in the figure represent an example and describe the variation of the pressure during a vacuum pulse in one case. The pressure values, the magnitude of the pressure variation and the duration of the vacuum pulse can vary in accordance with the embodiment.

By means of the ejector device 4 and the pressure medium accumulated in the pressure accumulator operating as its actuating medium, a vacuum shock according to FIG. 4 is provided by which it is easy to make the material being conveyed move and after that, by at least one vacuum pump 3, the motion of the material in the conveying pipe can be maintained.

According to the invention, the method relates to conveying material, advantageously waste material, by means of a pressure difference in the conveying pipe 100. According to the method, material is fed to the conveying pipe 100, and further in the conveying pipe to the separating device 20 in which the material being conveyed is separated from conveying air. To the conveying pipe 100 is achieved underpressure with at least one vacuum pump, as known per se, the suction side of which is connected to the separating device 20. In the method according to the invention, in the conveying piping 100, 101, 102 is provided the intensified generation of underpressure (a vacuum pulse) by an ejector device the suction side of which is connected to the conveying pipe either directly or by a pipeline connected to the separating device.

FIG. 2 shows another embodiment of the apparatus according to the invention, in which for generating basic underpressure in the conveying piping is used an ejector pump 3″ instead of vacuum pumps 3, 3′ in FIG. 1. The suction side of the ejector pump is coupled via the pipe 105 to the separator element 20, whereby suction is provided in the conveying pipe 100. As actuating medium, the ejector pump 3″ uses water which is pumped by a pump device 300 from a container 360 to an ejector nozzle 340. This provides suction on the suction side of the ejector pump which is connected to the pipe 105. Water, typically water mist, sprayed by the ejector nozzle returns to the container 360 from which it is conveyed to be re-sprayed by the pump. Also, the embodiment of FIG. 2 utilises another ejector device to provide an intensified vacuum effect (a vacuum shock) in the conveying pipe 100.

In the embodiments of FIGS. 1 and 2, the separator element 20, which is a so-called waste cyclone, the vacuum pump devices 3, 3′, 3″, the ejector unit 4 and the compressor unit 1 have been located at the delivery end of material of the material conveying system i.e. particularly in the waste conveying system into connection with the waste station. The feed points can be located decentralised along the system pipings distributedly. In connection with the waste conveying system, the feed points can be e.g. waste bins or waste chutes.

The invention thus relates to a method in a vacuum conveying system, which vacuum conveying system comprises at least one feed point 61, 66, a material conveying pipe 100, 101, 102 which is connected to the feed point 61, 66 and at the other end to a separator element 20 in which the material being conveyed is separated from conveying air, and means 3, 3′ for providing a pressure difference in the conveying pipe 100, 101, 102 at least for the time of conveying the material. In the method, in the conveying piping 100, 101, 102 is provided an intensified vacuum effect (a vacuum shock) by an ejector device 4, actuating medium of which ejector device is loaded in a pressure accumulator from which it is conveyed to an ejector nozzle for providing an intensive suction in the conveying pipe.

In accordance with an embodiment of the method, at least one vacuum pump unit 3, 3′, 3″ is used for providing basic underpressure in the conveying piping 100, 101, 102.

According to a typical embodiment, in the method, underpressure is maintained at least in the main conveying pipe 100 whereby, when emptying at least one feed point or equivalent, first the connection of the feed point is opened to the main conveying pipe 100, the line valve 62, 67 in the branch pipe 101, 102 of the feed point possibly open is closed, and an intensified vacuum effect is provided in the conveying pipe by the ejector device, the connection from the feed point to the conveying piping is closed, and the line valve 62, 67 of the branch pipe in question is opened for enabling the access of make-up air in the conveying pipe.

According to a typical embodiment, as the actuating medium of the ejector device 4 is used gas, such as compressed air.

According to another embodiment, as the actuating medium of the ejector device 4 is used liquid.

The actuating medium of the ejector device 4 is loaded in the pressure accumulator 16 by the pump means 12, such as a compressor.

The actuating medium of the ejector device 4 is loaded in the pressure accumulator in high pressure, such as e.g. about 10-40 bar. The pressure can also be higher than this, e.g. 40-300 bar.

According to another embodiment (FIG. 2), at least one ejector unit 3″ is used as the vacuum pump unit to provide basic underpressure in the conveying piping 100, 101, 102.

In the method, by the ejector device 4 the underpressure already provided by at least one vacuum pump 3, 3′, 3″ is momentarily intensified in the conveying piping 100.

The invention also relates to an apparatus in a vacuum conveying system, which vacuum conveying system comprises at least one feed point 61, 66, a material conveying pipe 100, 101, 102 which is connected to the feed point 61, 66 and at the other end to a separator element 20 in which the material being conveyed is separated from conveying air, and means 3, 3′, 3″ for providing a pressure difference in the conveying pipe 100, 101, 102 at least for the time of conveying the material. The apparatus comprises an ejector device 4 for providing an intensified vacuum effect (a vacuum pulse) in the conveying pipe 100 and for actuating medium of the ejector device of a pressure accumulator 16, from which pressure accumulator, pressure medium is conveyed to an ejector nozzle for providing an intensive suction in the conveying pipe 100.

The suction side of the ejector device 4 is connected to the separator element 20 from which there is a connection to the conveying pipe 100. The apparatus comprises a pump means 12 for loading the pressure accumulator 16.

According to an embodiment, the pressure accumulator 16 is a pneumatic accumulator. According to another embodiment, the pressure accumulator 16 is a hydraulic accumulator, whereby the actuating medium of the ejector 4 comprises liquid.

For generating basic underpressure in the conveying piping 100, 101, 102, at least one vacuum pump 3, 3′, 3″ is used.

According to an advantageous embodiment, the apparatus is fitted into connection with a waste conveying system. The material feed points 61, 66 are then advantageously the feed points of waste, such as waste bins or waste chutes.

Temporally, the length of the vacuum shock can vary e.g. from a few seconds to dozens of seconds. The values are dependent, inter alia, on the size of the system and the type and quality of material being conveyed.

It is obvious to those skilled in the art that the invention is not limited to the embodiments described above, but it may be varied within the scope of the enclosed claims. When necessary, the features possibly described in this specification together with other features may also be used separately from each other.

1. A method in a vacuum conveying system, which vacuum conveying system comprises at least one feed point (61, 66), a material conveying pipe (100, 101, 102) which is connected to the feed point (61, 66) and at the other end to a separator element (20) in which the material being conveyed is separated from conveying air, and means (3, 3′) for providing a pressure difference in the conveying pipe (100, 101, 102) at least for the time of conveying the material, characterised in that, in the method, in the conveying piping (100, 101, 102) is provided an intensified vacuum effect (a vacuum pulse) by an ejector device (4) actuating medium of which ejector device is loaded in a pressure accumulator (16) from which it is conveyed in an ejector nozzle for providing an intense suction in the conveying pipe.

2. A method according to claim 1 characterised in that, in the method, at least one vacuum pump unit (3, 3′) is used for providing basic underpressure in the conveying piping (100, 101, 102).

3. A method according to claim 1, characterised in that, in the method, underpressure is maintained at least in the main conveying pipe (100) whereby, when emptying at least one feed point or equivalent, first the connection of the feed point is opened to the main conveying pipe (100), a line valve (62, 67) in the branch pipe (101, 102) of the feed point possibly open is closed, and an intensified vacuum effect is provided in the conveying pipe by the ejector device, the connection from the feed point to the conveying piping is closed, and the line valve (62, 67) of the branch pipe in question is opened for enabling the access of makeup air in the conveying pipe.

4. A method according to claim 1, characterised in that as the actuating medium of the ejector device is used gas, such as pressurised air.

5. A method according to claim 1, characterised in that as the actuating medium of the ejector device (4) is used liquid.

6. A method according to claim 1, characterised in that the actuating medium of the ejector device is loaded in the pressure accumulator (16) by a pump means (12), such as a compressor.

7. A method according to claim 1, characterised in that the actuating medium of the ejector device (4) is gas which is loaded in the pressure accumulator (16) to high pressure, such as about 10-40 bar.

8. A method according to claim 1, characterised in that the actuating medium of the ejector device (4) is liquid which is loaded in the pressure accumulator (16) to high pressure, such as about 40-300 bar.

9. A method according to claim 1, characterised in that at least one ejector unit (3″) is used as the vacuum pump unit for providing basic underpressure in the conveying piping (100, 101, 102).

10. A method according to claim 1, characterised in that, in the method, the underpressure already provided by at least one vacuum pump (3, 3′, 3″) is momentarily intensified by the ejector unit (4) in the conveying piping (100, 101, 102).

11. An apparatus in a vacuum conveying system, which vacuum conveying system comprises at least one material feed point (61, 66), a material conveying pipe (100, 101, 102) which is connected to the feed point (61, 66) and at the other end to a separator element (20) in which the material being conveyed is separated from conveying air, and means (3, 3′) for providing a pressure difference in the conveying pipe (100, 101, 102) at least for the time of conveying the material, characterized in that the apparatus comprises an ejector device for providing an intensified vacuum effect (a vacuum pulse) in the conveying pipe (100), and a pressure accumulator (16) for actuating medium of the ejector device from which pressure accumulator the pressure medium is conveyed in an ejector nozzle for providing an intense suction in the conveying pipe (100).

12. An apparatus according to claim 11, characterized in that the suction side of the ejector device (4) is connected to the separator element (20) from which there is a connection to the conveying pipe (100).

13. An apparatus according to claim 11, characterized in that the apparatus comprises a pump means (12) for loading the pressure accumulator (16).

14. An apparatus according to claim 11, characterized in that the pressure accumulator (16) is a pneumatic accumulator.

15. An apparatus according to claim 11, characterized in that the pressure accumulator (16) is a hydraulic accumulator, whereby the actuating medium of the ejector (4) comprises liquid.

16. An apparatus according to claim 11, characterized in that at least one vacuum pump (3, 3′, 3″) is used for generating basic underpressure in the conveying piping (100, 101, 102).

17. An apparatus according to claim 11, characterized in that the apparatus is fitted into connection with a waste conveying system.

18. An apparatus according to claim 11, characterized in that the material feed points (61, 66) are waste feed points, such as waste bins or waste chutes.

19. A method according to claim 2, characterised in that, in the method, underpressure is maintained at least in the main conveying pipe (100) whereby, when emptying at least one feed point or equivalent, first the connection of the feed point is opened to the main conveying pipe (100), a line valve (62, 67) in the branch pipe (101, 102) of the feed point possibly open is closed, and an intensified vacuum effect is provided in the conveying pipe by the ejector device, the connection from the feed point to the conveying piping.

20. A method according to claim 2, characterised in that as the actuating medium of the ejector device is used gas, such as pressurised air.
